(19) United States
(12) Patent Application Publication
(10) Pub. No.: US 2026/0233942 A1
(43) Pub. Date: Aug. 13, 2026

(54) APPARATUS, MEMBER AND METHOD FOR TRANSFERRING PRODUCTS AND METHOD FOR SETTING UP THE APPARATUS

(71) Applicant: I.M.A. INDUSTRIA MACCHINE AUTOMATICHE S.P.A., OZZANO DELL'EMILIA (BO) (IT)

(72) Inventor: Fabrizio TALE', OZZANO DELL'EMILIA (BO) (IT)

(21) Appl. No.: 19/155,396

(22) PCT Filed: Feb. 12, 2024
(86) PCT No.: PCT/IT2024/050033

§ 371 Date: Aug. 11, 2025

(30) Foreign Application Priority Data
Feb. 13, 2023 (IT) 102023000002355

(51) Int. Cl. B65G 47/06; A24C 5/32; A24C 5/35; B65B 35/36; B65G 17/34; B65G 47/86

(52) U.S. Cl. CPC B65G 47/06; A24C 5/322; A24C 5/35; B65B 35/36; B65G 47/847; B65G 17/34; B65G 2201/0217; B65G 2201/0226

(57) ABSTRACT

Apparatus (10; 10′) for transferring products (100), in particular tubular products, comprising a transfer member (20) for transferring the products (100) which is provided with a cam body (24) in which there are created, on complementary segments, at least a first (25) and a second (26) cam paths, at least one gripping member (21) configured to temporarily hold one of said products (100) and mounted mobile on the body (24) so as to travel, in cyclical sequence, the first (25) and second (26) cam paths; and a conveyor (30) configured to receive the products (100) from the gripping member (21) and provided with one or more seatings (33), each configured to receive a respective product (100).

### FIELD OF THE INVENTION

The present invention concerns an apparatus and a method for transferring products, in particular products with a tubular shape, to transfer them from a feed member toward a conveyor.

The feed member and the conveyor can, for example, be part of a packaging plant or machine, in which it is provided to transfer the products from the feed member to the conveyor, which carries them toward a subsequent packaging station.

The present invention also concerns both a transfer member for transferring the products, and also a method for setting up the transfer apparatus.

### BACKGROUND OF THE INVENTION

As is known, there are automated machines for packaging tubular products, in particular smoking articles or straws, in which there is the need to transfer the products from a rotating member to a conveyor line by means of transfer systems.

Very frequently, the transfer systems comprise one or more wheels provided, at a perimeter edge thereof, with a plurality of gripping members, each of which is configured to travel cyclically first to a pick-up position for picking up the products from the rotating member and subsequently, after the wheel has rotated by a certain angle, to a product delivery position, in which the products are deposited on the conveyor line. The gripping members known in the state of the art can be either of a mechanical nature, such as for example grippers, or of a pneumatic nature, for example suckers.

The conveyor line in turn transfers the products, distanced from each other by a predetermined linear pitch and in an orderly manner, toward a packaging station in which the products are packaged inside containers, for example packets or pouches or bags, moved by a respective movement line.

The number of articles inside each container can be variable, according to requirements. However, once this number has been set, the operation of the machine is perfected based on that number. When it is necessary to package batches of containers each comprising a number of products different from the number of products of the batch that has been packaged previously, the solutions known in the state of the art require long and laborious machine set-up operations. The most common of these operations comprise replacing sized parts and/or adjusting certain members, and/or modifying the instructions to the machine control software.

It is clear there is a considerable disadvantage in known automated machines, which because they are able to package as many as tens of thousands of products per hour are typically able to reach very high productivity, because every time the number of products to be packaged inside each container has to be changed, the machine has to be stopped for a long time, resulting in lost productivity.

In a field other than packaging machines, EP 4085935 describes a solution capable of transporting articles to be sterilized, in a sterilizer, capable of transporting the articles to be sterilized alternately distanced from each other by a first pitch, or by a second pitch, wherein the pitch is chosen according to the number of articles to be sterilized in the unit of time.

There is therefore the need to provide an apparatus and to develop a corresponding method for transferring products, in particular tubular products, that can overcome at least one of the disadvantages of the state of the art.

One purpose of the present invention is to provide an apparatus and a member for transferring products, as well as to develop a corresponding transfer method, which are versatile and flexible, in particular able to be adapted simply and quickly in the event the number of products to be packaged inside each container has to be changed.

Another purpose of the present invention is to develop a method for setting up the apparatus for transferring tubular products that is simple and quick to carry out, so as to limit machine downtime as much as possible.

Another purpose of the present invention is to provide an apparatus and a member for transferring products, as well as to develop a corresponding method, which are able to deposit the products on a conveyor line at a desired linear pitch, in a reliable and precise manner.

Another purpose of the present invention is to provide a compact apparatus, and to develop a corresponding automatic set up method, which do not cause a significant increase in the complexity and sizes of the packaging machine in which their use can be provided.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, the invention concerns an apparatus for transferring products, in particular tubular products, comprising a transfer member for transferring the products. The transfer member comprises a cam body provided with at least a first and a second cam paths; and at least one gripping member configured to cooperate with the cam body to travel along the first and the second cam paths. The apparatus further comprises at least one conveyor for the products having a plurality of seatings each configured to receive a respective product from the gripping member.

According to one aspect of the present invention, the first and second cam paths are shaped according to different profiles, so that when the at least one gripping member travels the first cam path it deposits the products in the seatings which are distanced from each other by a first pitch, when the at least one gripping member travels the second cam path it deposits the products in the seatings which are distanced from each other by a second pitch, which is different from the first pitch.

The shape of the profile of the first cam path is correlated to the first pitch, while shape of the profile of the second cam path is correlated to the second pitch.

According to one aspect of the present invention, the at least a first and second cam paths together define a single closed path.

According to one aspect of the present invention, the at least one gripping member is configured to follow the at least a first and second cam paths in cyclical sequence, in such a way that it picks up one of the products in a first pick-up position, and subsequently releases the picked-up product in a first delivery position, in which the gripping member deposits the product on one of the seatings of the at least one conveyor, wherein both the first pick-up and first delivery positions are located either along the first cam path or along the second cam path, so as to be reached by the at least one gripping member when it travels either the first cam path or the second cam path, respectively.

According to one aspect of the present invention, the at least one gripping member comprises an actuator element, which acts as a cam follower, mobile along the first and second cam paths.

According to one aspect of the present invention, each gripping member comprises two gripping arms, mobile with respect to each other and forming holding grippers, and also comprises a cam mechanism configured to move the gripping arms between a position in which they are neared to each other, when the gripping member is holding one of the products, and a second position in which they are distanced from each other, when the gripping member is not holding any product.

According to one aspect of the present invention, the cam body is rotatable mounted about an adjustment axis to switch the position between the first and the second cam paths.

According to one aspect of the present invention, the first and second cam paths respectively extend over a portion subtended by an angle equal to 180°.

According to one aspect of the present invention, the seatings are distanced from each other by a reference pitch measured parallel to an advancement direction of the conveyor.

According to one aspect of the present invention, the first and second pitches are equal to a respective different multiple of the reference pitch with a multiplier comprised between one and six.

According to one aspect of the present invention, the seatings are provided on a plurality of conveyors located side by side which are comprised in the conveyor. According to one aspect of the present invention, the apparatus comprises at least one feed member for feeding the products to the transfer member, wherein the feed member is rotatable about a first rotation axis.

According to one aspect of the present invention, the apparatus comprises an additional conveyor. According to this embodiment, the at least one gripping member of the transfer member is also configured to pick up one of the products in a second pick-up position, and subsequently to release the product, which has been picked up at the second pick-up position, in a second delivery position, in which the gripping member deposits the product inside an additional seating of the additional conveyor. The second pick-up position and the second delivery position are different from the first pick-up position and the first delivery position, respectively, and both the second pick-up and delivery positions are located either along the second cam path or along the first cam path.

According to another aspect of the present invention, a transfer member is provided for transferring products comprising a cam body provided with at least a first and a second cam paths, and at least one gripping member configured to cooperate with the cam body to travel along the first and the second cam paths.

According to another aspect of the present invention, the first and second cam paths are shaped according to different profiles, so that when at least one gripping member travels the first cam path it deposits the products distanced from each other by a first pitch, while when the at least one gripping member travels the second cam path it deposits the products distanced from each other by a second pitch, which is different form the first pitch.

According to another aspect of the present invention, the at least a first and second cam paths together define a single closed path.

According to another aspect of the present invention, the at least one gripping member is configured to follow the at least a first and second cam paths in cyclical sequence, in such a way that it picks up one of the products in a first pick-up position, and subsequently releases the picked-up product in a first delivery position, wherein both the first pick-up and delivery positions are located either along the first cam path or along the second cam path, so as to be reached by the at least one gripping member when it travels either along the first cam path or along the second cam path, respectively.

According to another aspect of the present invention, a method is provided for transferring products, in particular tubular products, in an apparatus comprising on or more of the aspects described above.

According to one aspect of the present invention, the method comprises a transfer step in which the products are transferred to the conveyor by means of the at least one gripping member, and a delivery step in which the products are delivered in the seatings by the at least one gripping member. During the delivery step, the gripping member deposits the products distanced from each other either by a first pitch when it travels the first cam path or by a second pitch, different from the first pitch, when the gripping member travels the second cam path. During the transfer and delivery steps, the at least one gripping member picks up one of the products in a first pick-up position, and subsequently releases the picked-up product in a first delivery position, in which the gripping member deposits the product on one of the seatings of the at least one conveyor, wherein both the first pick-up and delivery positions are located either along the first cam path or along the second cam path, so that the at least one gripping member reaches the first pick-up and delivery positions when it travels either the first cam path or the second cam path, respectively.

According to one aspect of the present invention, the method comprises a feeding step in which the products are fed from a feed member to the transfer member.

According to another aspect of the present invention, a method is provided for setting up an apparatus comprising a rearrangement step in which the cam body is rotated about an adjustment axis by a predetermined angle, for example of 180°, so that the relative positions of the first and second cam paths with respect to the conveyor are switched.

The apparatus and the transfer member, as well as the methods, according to the present invention advantageously allow to easily and rapidly modify the pitch between the tubular products placed on the conveyor.

This can be achieved thanks to the fact that the transfer member's cam body comprises a first and a second cam paths, which together form a single closed path and which the gripping members travel.

Since the profile that defines the first cam path is such that the gripping member deposits the products in the delivery position distanced from each other by the first pitch, and the profile that defines the second cam path is such that the gripping member deposits the products in the delivery position distanced from each other by the second pitch, it is sufficient to switch the positions of the first and second cam paths with respect to the conveyor in order to easily modify the pitch that distances the products from each other on the line.

Advantageously, this can be achieved through the method for setting up the apparatus, which provides to disassemble the transfer member and rearrange it rotated by a certain angle with respect to the arrangement prior to disassembly. This method is quick and easy to carry out, even for an operator who is not highly specialized.

It is clear that the apparatus, the member and method for transferring products are very versatile and able to easily adapt to different production circumstances that require a change in the pitch of the products on the line, for example to change the number of products to be packaged inside each packaging casing.

Advantageously, the apparatus and method allow to achieve high productivity and, in some cases, also to supply different packaging stations with products placed at a different pitch.

### DESCRIPTION OF THE DRAWINGS

These and other aspects, characteristics and advantages of the present invention will become apparent from the following description of some embodiments, given as a non-restrictive example with reference to the attached drawings wherein:

FIGS. 1 and 2 are schematic and simplified front views of an apparatus in accordance with an embodiment of the present invention, shown in two different operating modes;

FIGS. 1a and 2a are enlarged detailed views of a portion of FIGS. 1 and 2, wherein in FIG. 1a a gripping member comprised in the apparatus is shown in the delivery position;

FIG. 3 is a schematic and simplified front view of an apparatus in accordance with another embodiment of the present invention;

FIG. 4 is a view like that of FIG. 3, and constitutes a variant thereof.

We must clarify that in the present description the phraseology and terminology, such as for example the terms horizontal, vertical, lower, upper, high and low, with their declinations, have the sole function of better illustrating the present invention with reference to the attached drawings and must not be in any way used to limit the scope of the invention itself, or the field of protection defined by the attached claims. For example, by the term “horizontal” we mean an axis or plane, which can be either parallel to the line of the horizon or inclined with respect thereto, even by several degrees—for example up to 20°.

Moreover, the people of skill in the art will recognize that certain sizes or characteristics in the drawings may have been enlarged, deformed, or shown in an unconventional or non-proportional manner in order to provide a version of the present invention that is easier to understand. When sizes and/or values are specified in the following description, the sizes and/or values are given for illustrative purposes only and must not be construed as limiting the scope of protection of the present invention, unless such sizes and/or values are included in the attached claims.

To facilitate comprehension, the same reference numbers have been used, where possible, to identify identical common elements in the drawings. It is understood that elements and characteristics of one embodiment can be conveniently incorporated into other embodiments without further clarifications.

### DESCRIPTION OF SOME EMBODIMENTS OF THE PRESENT INVENTION

With reference to FIGS. from 1 to 4, an apparatus 10 according to the present invention is configured to transfer tubular products 100, hereafter also referred to simply as products 100 for short.

Before describing the apparatus 10 and its operation in detail, we will now describe an example of a tubular product 100.

Purely by way of indication and to better frame one of the fields of application of the present invention, each tubular product 100 can be a straw having an external diameter comprised between about 2 mm and about 20 mm, preferably between about 4 mm and about 10 mm, and a length comprised between about 80 mm and about 200 mm.

By way of a non-limiting example, the straw can be made of plastic materials, for example polyethylene or polypropylene.

It is understood that, in other embodiments, the apparatus 10 can transfer tubular products 100 other than straws, for example, conventional smoking articles, e-cigarette cartridges, cosmetic products, stationery materials, or more generally any other tubular-shaped element whatsoever having a much greater extension in the longitudinal direction than the overall transverse size (diameter).

The apparatus 10 comprises a frame 11, shown schematically in the drawings, which supports in a known manner the various components of the apparatus, which are mobile with respect thereto.

The apparatus 10 comprises a first feed member 12 for feeding the products 100. In the example given here, the first feed member 12 is configured as a wheel.

The first feed member 12 is rotatable about a first rotation axis X1, in particular, in the example shown, counterclockwise, as indicated by the arrow R1.

The first feed member 12 comprises a plurality of housings 13 for the products 100. In the non-limiting example given here, nine housings 13 are provided, intended to receive as many products 100. Preferably, the housings 13 are placed on a peripheral edge of the wheel, and are angularly equidistant from each other by a same central angle, measured with reference to the first rotation axis X1.

In the path segment in which the products 100 are received in the housings 13, an abutment element 14 can be provided. The abutment element 14 is shaped so as to surround the first feed member for an arc of circle corresponding to the path segment. Between the first abutment element and the peripheral edge of the first feed member 12, there is defined a passage hollow space 15 in which the housings 13 pass, each carrying one respective product 100.

The apparatus 10 comprises a transfer member 20 for transferring the products 100 which comprises at least one gripping member 21. In the example shown, six gripping members are provided, angularly equidistant from each other, but it is clear that a higher or lower number can also be provided.

Each gripping member 21 comprises two gripping arms, in particular a fixed arm 22 and a mobile arm 23. The movement of the mobile arm 23 is commanded by a cam mechanism 28, which alternately takes it neared to the fixed arm 22, when the gripping member 21 is holding a product 100, or distanced from the fixed arm 22, when the gripping member 21 is not holding any product 100.

In the example given here, the transfer member 20 is substantially conformed as a disc, the center of which is defined by an adjustment axis X2, so named for reasons that will be clarified below, in the context of the description of the set-up method.

The transfer member 20 comprises a fixed cam body 24, with respect to which the gripping members 21 are mobile, with different degrees of freedom of movement, for example three. In addition to being able to travel in the two-dimensional plane, each gripping member 21 can oscillate, for example by a few degrees, with respect to the cam body 24, about its own oscillation axis X3.

A first 25 and a second 26 cam paths are made on the cam body 24, each having a different profile from the other, which together form complementary segments of a single closed path, indicated as a whole with a dashed line. To schematically distinguish the position of the first cam path 25 from that of the second cam path 26 in the drawings, the two semi-halves of the cam body 24 in which the respective cam paths extend have been filled with different backgrounds: with dashes in the portion of the cam body 24 along which the first cam path 25 extends, and with dots in the portion of the cam body 24 along which the second cam path 26 extends.

In the example given here, each cam path 25, 26 extends for a portion subtended by an angle equal to about 180°.

In other variants, not shown, three or more different cam paths can also be provided. In this case, each of them extends for a portion subtended by an angle correlated to the number of cam paths, for example 120° in the case of three different cam paths.

Each gripping member 21 comprises an actuator element 27 configured to engage with the first and second cam paths 25, 26. In the example given here, the actuator element 27 is configured as a wheel that runs along the profile of these cam paths, acting as cam follower.

The apparatus 10 further comprises a conveyor 30 of the products 100, configured to receive the products from the transfer member 20. In the example given here, the conveyor 30 advances the products 100 in an advancement direction A, toward a subsequent processing station, for example a station for packaging the products inside a casing.

The conveyor 30 comprises a conveyor belt 31, closed in a loop on two rollers (only one shown in the drawings), at least one of which being a motorized roller 32, to determine the advancement of the conveyor belt 31 thanks to the rotation of the motorized roller 32.

A plurality of seatings 33 are provided on the conveyor 30, each configured to receive a respective product and having shape and sizes correlated to those of the products 100. The seatings 33 are placed side by side to each other and are distanced from each other by a reference pitch P, measured parallel to the advancement direction A.

In the example given here, the conveyor 30 comprises a plurality of conveyor elements 34, on which the seatings 33 are made. The conveyor elements 34 are attached to the conveyor belt 31 in any known manner whatsoever, for example by means of attachment elements, including screws or bolts.

The conveyor elements 34 are placed side by side to each other in such a way that two consecutive seatings 33, made on two different conveyor elements 34 placed side by side, remain distanced from each other by the reference pitch P.

In other embodiments, not shown, it is provided that the seatings 33 are made directly on the conveyor belt 31, which for example can be a toothed chain, with the seatings made between one tooth and the other.

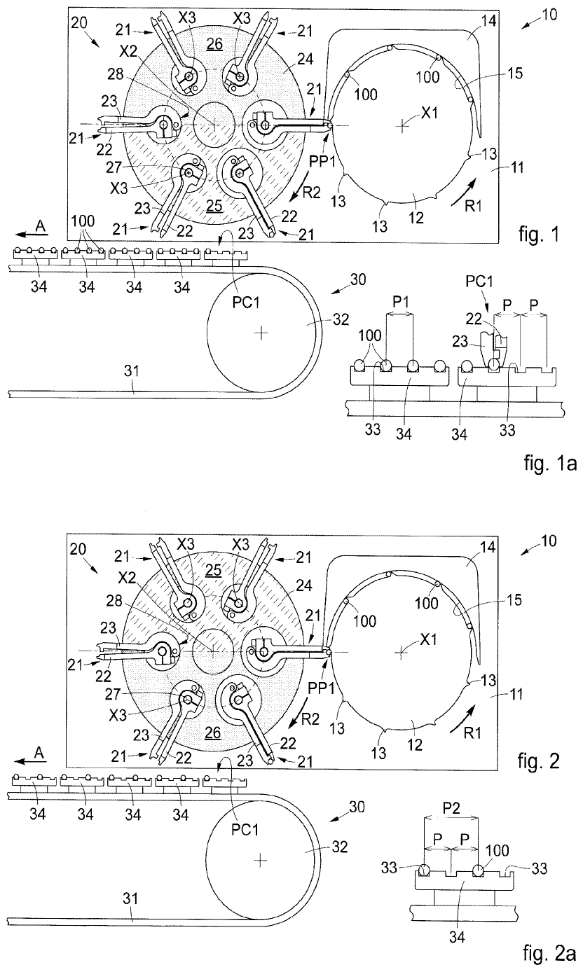

In the embodiments shown in FIGS. 1-3 each conveyor element 34 comprises four seatings 33, while in the embodiment shown in FIG. 4 each conveyor element 34 comprises five seatings 33. It is evident that in other embodiments each conveyor element 34 can also comprise a number of seatings 33 larger than or smaller than four or five.

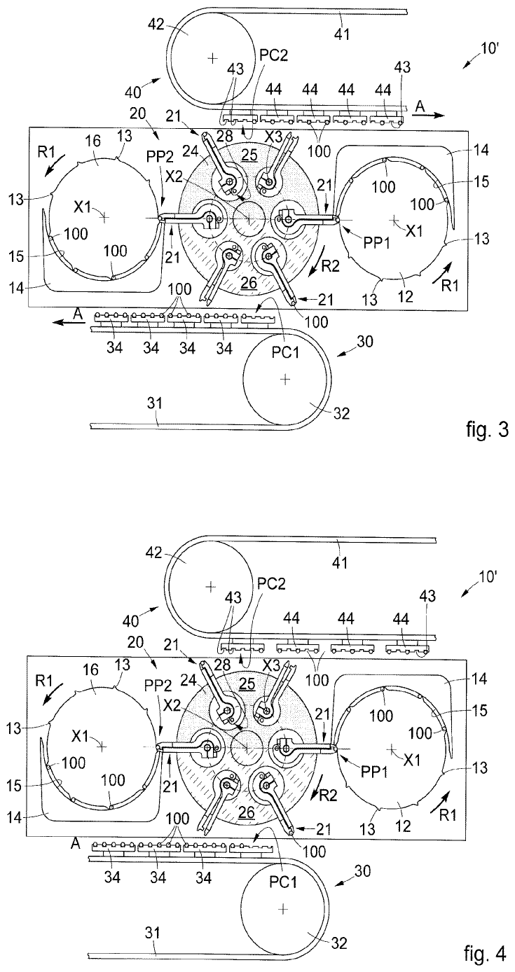

With reference to FIG. 3, another embodiment of an apparatus 10′ according to the present invention is shown, in which, unless otherwise specified, for reasons of clarity the same reference numbers will refer to components similar or the same as those already described previously, with reference to FIGS. 1 and 2.

The apparatus 10′ comprises the first feed member 12, the transfer member 20 and the conveyor 30 described above with reference to FIGS. 1 and 2.

In addition, the apparatus 10′ comprises an additional feed member 16 and an additional conveyor 40 which are respectively positioned on the opposite side of the first feed member 12 and of the conveyor 30, with respect to the transfer member 20, which in this configuration therefore assumes a central position. The additional feed member 16 is structurally and functionally similar to the first feed member 12, and the additional conveyor 40 is structurally and functionally similar to the conveyor 30, therefore their description will not be repeated here for reasons of brevity. For the sake of clarity, in FIGS. 3 and 4 the conveyor belt, the motorized roller, the seatings and the conveyor elements are indicated respectively with the reference numbers 41, 42, 43 and 44.

The apparatus 10, 10′ comprises a plurality of drive members, not shown, for example of the brushless type or of the stepper type, to drive the feed member 12 and the motorized roller 32, 42 in rotation, as well as to determine the movement of the gripping members 21.

The apparatus 10, 10′ further comprises a programmable central control unit, which coordinates the operation of the drive members for the correct operation of the apparatus, since it is evident that the linear advancement speed of the conveyors 30, 40 in the advancement direction A has to be functionally correlated, in a controlled manner, to the movement speed of the gripping members 21, and the latter speed with the rotation speeds of the feed members 12, 16.

The operation of the apparatus 10, 10′, which corresponds to the method for transferring products according to the present invention, is described below.

The products 100 are fed from the first feed member 12 to the transfer member 20 at a first pick-up position PP1, in which a product 100 is picked up from one of the housings 13 by means of a gripping member 21.

While the gripping member is reaching the first pick-up position PP1, it has the two arms 22, 23 in a distanced position. When it arrives at the first pick-up position PP1, the two arms move into a position neared to each other, so as to grip and hold the product 100 between them.

After this, the gripping member 21 advances until it arrives at the first delivery position PC1, as visible in the enlarged detail of FIG. 1a.

In a first operating mode of the apparatus 10 (FIG. 1), in the path that the gripping member 21 follows from the first pick-up position PP1 to the first delivery position PC1, the actuator element 27 is following the profile of the first cam path 25.

This causes the gripping members 21 to deliver the products 100 in the seatings 33 distanced from each other by a first pitch P1, as better visible in the enlarged detail of FIG. 1a. According to this example, in the first operating mode the first pitch P1 is equal to the reference pitch P between the seatings 33. In other words, all the seatings 33 are filled with a respective product.

Instead, in a second operating mode of the apparatus 10 (FIG. 2), in the path that the gripping member 21 follows from the first pick-up position PP1 to the first delivery position PC1, the actuator element 27 is following the profile of the second cam path 26.

This causes the gripping members 21 to deliver the products 100 in the seatings 33 distanced from each other by a second pitch P2, better visible in the enlarged detail of FIG. 2a. According to this example, in the second operating mode the second pitch P2 is an integer multiple of the reference pitch P between the seatings 33, being substantially double the reference pitch. In other words, the gripping members 21 deliver the products on alternate seatings 33, placed on the sides of seatings that remain empty.

The conveyor 30 then advances the conveyor elements 34 toward a packaging station, not shown, where the products 100 are packaged in respective packaging casings.

In the example given here, the apparatus 10 operates according to the first operating mode if each packaging casing is to contain four products, that is, the four products grouped on the same conveyor element 34.

Alternatively, the apparatus 10 follows the second operating mode if each packaging casing is to contain only two products, that is, the two present on the same conveyor element 34.

The gripping member then continues in its movement from the first delivery position PC1 to return to the first pick-up position PP1, and subsequently the operation described above is repeated cyclically.

In the path between the first delivery position PC1 and the first pick-up position PP1, in the first operating mode the actuator element 27 engages mainly with the second cam path 26 (FIG. 1), while in the second operating mode the actuator element 27 engages mainly with the first cam path 25 (FIG. 2). Along this path, the arms 22, 23 are in a distanced position and remain in this position until the gripping member 21 once again reaches the first pick-up position PP1.

With reference to the embodiment of FIG. 3, after the gripping member 21 has delivered the product 100 into a respective seating 33 of the conveyor 30, as described above with reference to the first operating mode of FIG. 1, it reaches a second pick-up position PP2, in which it receives a product 100 from a respective housing 13 of an additional feed member 16. Between the first delivery position PC1 and the second pick-up position PP2, the arms 22, 23 are in a distanced position, so as to move into a neared position in the second pick-up position PP2, so as to be able to grip and hold the product 100.

Subsequently, the gripping member 21 continues its movement until it reaches a second delivery position PC2, in which it delivers the product 100 received from the additional feed member 16 in the second pick-up position PP2 in a seating 43 made on an additional conveyor 40.

After this, the gripping member 21 continues its travel and reaches the first pick-up position PP1 to repeat the operation described above cyclically. Between the second delivery position PC2 and the first pick-up position PP1, the arms 22, 23 are in a distanced position, so as to move once again into a neared position in the first pick-up position PP1, so as to be able to grip and hold the product 100.

In this embodiment, the apparatus 10′ simultaneously allows both to deliver the products 100 on the seatings 33 of the conveyor 30 distanced from each other by the first pitch P1, and also to deliver the products 100 on the seatings 43 of the additional conveyor 40 distanced from each other by the second pitch P2. In this case, the packaging machine in which the apparatus 10′ is comprised could comprise a first packaging station, in which it is provided to package a certain number of products 100, for example four, in a same casing, and a second packaging station in which it is provided to package another number of products 100, for example two, in a same casing.

This is possible because between the first PP1 and the second PP2 pick-up positions the actuator element 27 of the gripping members 21 engages mainly with the first cam path 25, while between the second PP2 and the first PP1 pick-up positions the actuator element 27 engages mainly with the second cam path 26.

The operation of the embodiment of FIG. 4 is substantially similar to that of FIG. 3, with the difference that each conveyor element 34, 44 of the conveyor 30 and, respectively, of the additional conveyor 40 comprises five seatings 33, and can therefore comprise up to a maximum of as many products. In this example, the transfer member 20 deposits the products 100 on the seatings 33 of the conveyor 30 distanced from each other by the first pitch P1, which in this example is equal to the reference pitch P between the seatings 33, and also deposits the products 100 on the seatings 43 of the additional conveyor 40 distanced from each other by the second pitch P2, which in this example is equal to twice the reference pitch P between the seatings 33.

The packaging machine in which the apparatus 10′ shown in FIG. 4 is comprised could comprise a first packaging station, in which it is provided to package a certain number of products 100, for example five, in a same casing, and a second packaging station in which it is provided to package another number of products 100, for example three, in a same casing.

With particular reference to FIGS. 1 and 2, we will now describe a method for setting up the apparatus 10 according to the present invention. This set-up method allows the operation of the apparatus 10 to be easily and quickly switched from the first to the second operating mode described above, or vice versa.

When the production circumstances require a change in the number of products 100 to be packaged inside each packaging casing, it is sufficient to disassemble the transfer member 12 and rearrange it in a position rotated by a certain angle, for example by 180° in the example shown, about the adjustment axis X2. To this end, the transfer member 12 comprises suitable temporary attachment means, which comprise mechanical components known in the art such as for example threaded elements, such as screws or bolts, and pins or keys, which allow to temporarily attach the transfer member 12 to its support through screwing or same-shape couplings between the parts involved.

In the example shown, in order to switch from the first to the second operating mode, it can be observed that before the transfer member 20 is disassembled, the cam body 24 is arranged in such a way that the first cam path 25 is in the lower semi-half and the second cam path 26 is in the upper semi-half (FIG. 1), while after the transfer member 20 has been rearranged, the cam body 24 is arranged in such a way that the second cam path 26 is in the lower semi-half and the first cam path 25 is in the upper semi-half (FIG. 2).

Conversely, to switch from the second operating mode to the first operating mode, it is necessary to repeat the disassembly and rearrangement operations in order to make the transfer member 20 switch from the configuration of FIG. 2 to that of FIG. 1.

It is clear that modifications and/or additions of parts or steps may be made to the apparatus and methods as described heretofore, without departing from the field and scope of the present invention, as defined by the claims.

It is also clear that, although the present invention has been described with reference to some specific examples, a person of skill in the art will certainly be able to achieve many other equivalent forms of apparatuses, methods and/or machines, having the characteristics as set forth in the claims and hence all coming within the scope of protection defined thereby.

As evident from the scope of protection defined in the following claims, the transfer member 20 described above can also be installed in a different context from that of the apparatus 10, for example in another type of machine or plant, while still falling within the scope defined by the following claims.

In the following claims, the sole purpose of the references in brackets is to facilitate reading and they must not be considered as restrictive factors with regard to the field of protection defined by the claims.

1. Apparatus for transferring products, in particular tubular products, said apparatus comprising:
a transfer member comprising:—a cam body provided with at least a first and a second cam paths; and
at least one gripping member configured to cooperate with said cam body to travel along said first and said second cam paths; said apparatus further comprising at least one conveyor having a plurality of seatings each configured to receive a respective product from said at least one gripping member; wherein said first and second cam paths are shaped according to different profiles, so that when said at least one gripping member travels said first cam path it deposits said products in said seatings distanced from each other by a first pitch, while when said at least one gripping member travels said second cam path it deposits said products in said seatings distanced from each other by a second pitch which is different from said first pitch, characterized in that the at least a first and second cam paths together define a single closed path, and in that said at least one gripping member is configured to follow said at least a first and second cam paths in cyclical sequence, in such a way that it picks up one of said products in a first pickup position, and subsequently releases the picked-up product in a first delivery position, in which said gripping member deposits the product on one of said seatings of said at least one conveyor, wherein both said first pick-up and first delivery positions are located either along said first cam path or along said second cam path, so as to be reached by the at least one gripping member when it travels either said first cam path or said second cam path, respectively.

2. Apparatus as in claim 1, wherein said at least one gripping member comprises an actuator element, which acts as a cam follower, mobile along said first and second cam paths.

3. Apparatus as in claim 1, wherein each gripping member comprises two gripping arms mobile with respect to each other, and also comprises a cam mechanism configured to move said two gripping arms between a first position in which they are neared to each other, when said gripping member is holding one of said products, and a second position in which they are distanced from each other, when said gripping member is not holding any product.

4. Apparatus as in claim 1, wherein said cam body is rotatable mounted about an adjustment axis to switch the position between the first and the second cam paths.

5. Apparatus as in claim 1, wherein said first and second cam paths respectively extend over a portion subtended by an angle equal to 180°.

6. Apparatus as in claim 1, wherein said seatings are distanced from each other by a reference pitch measured parallel to an advancement direction of said conveyor, and in that said first and second pitches are equal to a respective different multiple of said reference pitch with a multiplier comprised between one and six.

7. Apparatus as in claim 1, wherein said seatings are provided on a plurality of conveyors located side by side and comprised in said conveyor.

8. Apparatus as in claim 1, wherein it comprises at least one feed member for feeding said products to said transfer member, said at least one feed member being rotatable about a first rotation axis.

9. Apparatus as in claim 1, wherein it comprises an additional conveyor, and in that said at least one gripping member of said transfer member is also configured to pick up one of said products in a second pick-up position and subsequently to release the product which has been picked up at said second pick-up position, in a second delivery position in which the gripping member deposits the product inside an additional seating of said additional conveyor, wherein said second pick-up position and said second delivery position are different from said first pick-up position and said first delivery position respectively, and wherein both said second pick-up and delivery positions are located either along said second cam path or along said first cam path.

10. Transfer member for transferring products comprising:
a cam body provided with at least a first and a second cam paths(25, 26); and
at least one gripping member configured to cooperate with said cam body to travel along said first and said second cam paths; wherein said first and second cam paths are shaped according to different profiles, so that when at least one gripping member travels said first cam path it deposits said products distanced from each other by a first pitch, while when said at least one gripping member travels said second cam path it deposits said products distanced from each other by a second pitch different form the first pitch, wherein the at least a first and second cam paths together define a single closed path, and in that said at least one gripping member is configured to follow said at least a first and second cam paths in cyclical sequence, in such a way that it picks up one of said products in a first pickup position, and subsequently releases the picked-up product in a first delivery position, wherein both said first pick-up and delivery positions are located either along said first cam path or along said second cam path so as to be reached by said at least one gripping member when it travels either along said first cam path or along said second cam path, respectively.

11. Transfer member as in claim 10, wherein said at least one gripping member comprises an actuator element, which acts as a cam follower, mobile along said first and second cam paths.

12. Transfer member as claim 10 wherein said cam body is rotatable mounted about an adjustment axis to switch the position between the first and the second cam paths.

13. Method for transferring products, in particular tubular products, in an apparatus comprising a transfer member for transferring said products, said transfer member comprising a cam body provided with at least a first and a second cam paths, and at least one gripping member configured to cooperate with said cam body to travel along said first and second cam paths, wherein said first and second cam paths are shaped according to different profiles, said apparatus further comprising at least one conveyor having a plurality of seatings, each configured to receive a respective product, wherein said method comprises a transfer step in which said products are transferred to said conveyor by means of said at least one gripping member and a delivery step in which said products are delivered by said at least one gripping member in said seatings, wherein during said delivery step, said gripping member deposits said products distanced from each other either by a first pitch when it travels said first cam path or by a second pitch, different from said first pitch, when said gripping member travels said second cam path, wherein the at least a first and second cam paths together define a single closed path followed by said at least one gripping member in cyclical sequence, in such a way that during said transfer and delivery steps, said at least one gripping member picks up one of said products in a first pick-up position, and subsequently releases the picked-up product in a first delivery position, in which said gripping member deposits the product on one of said seatings of said at least one conveyor, wherein both said first pick-up and delivery positions are located either along said first cam path or along said second cam path, so that the at least one gripping member reaches said first pick-up and delivery positions when it travels either said first cam path or said second cam path, respectively.

14. Method as in claim 13, wherein a feeding step in which said products are fed from a feed member to said transfer member.

15. Method for setting up an apparatus as in claim 4, wherein a rearrangement step in which said cam body is rotated about the adjustment axis by a predetermined angle, so that the relative positions of said first and second cam paths with respect to said conveyor are switched.
